(19) United States
(12) Patent Application Publication
(10) Pub. No.: US 2016/0014099 A1
(43) Pub. Date: Jan. 14, 2016

(54) SYSTEM AND METHOD FOR SECURE VOIP COMMUNICATION

(71) Applicant: ICELERO INC, San Jose, CA (US)

(72) Inventor: Daniel Fishkov, San Jose, CA (US)

(21) Appl. No.: 14/771,734

(22) PCT Filed: Mar. 7, 2013
(86) PCT No.: PCT/US13/29570

§ 371 Date: Aug. 31, 2015

(51) Int. Cl. H04L 29/06; H04W 12/06

(52) U.S. Cl. CPC H04L 63/0492; H04L 63/0876; H04W 12/06; H04L 63/0853

(57) ABSTRACT

A system, method and computer program product for secure voice over IP (VoIP) communications between computer devices, including a mobile device having a voice over IP (VoIP) application running thereon; a memory device having an encryption and decryption application, and an audio interface application running thereon; and a bus for providing communication between the mobile device and the memory device. The encryption and decryption application is configured to encrypt data transmitted to and received from the VoIP application over the bus. The encryption and decryption application is configured to decrypt the data received from the VoIP application before sending the decrypted data to the audio interface application.

### BACKGROUND OF THE INVENTION

1. Field of the Invention

The present invention generally relates to systems and methods for secure communications over voice over IP (VoIP), and more particularly to a method and system for secure VoIP communications using mobile phones, tablets, personal computers systems, and the like.

2. Discussion of the Background

In recent years, there has been increased presence of various types of malware software, and the like, on mobile devices, as well as personal computers, and the like, that can be used to eavesdrop on communications, including voice over IP (VoIP) communications, and the like, and compromise security keys, communication data, process stolen data, and the like. Such malware also can take over an operating system, opening illegal access to other applications, drivers, data space, and the like, and obtain access to sensitive information, including security keys used for data encryption and decryption, and the like, as well as any unencrypted data itself. However, existing systems and methods that process voice over IP (VoIP) communications may lack in security allowing for eavesdropping by malware, viruses, bots, and the like, so as to compromise voice and data security of communications, and the like.

### SUMMARY OF THE INVENTION

Therefore, there is a need for a method and system that address the above and other problems with systems and methods for securing communications over voice over IP (VoIP) on mobile devices, such as phones, tablets, personal computers systems, and the like by preventing eavesdropping, and the like, on the device itself. The above and other problems are addressed by the illustrative embodiments of the present invention which provide a method and system that significantly reduce exposure of sensitive and classified information, such as security keys, unencrypted communication data, and the like, while processing voice over IP (VoIP) communications is a secure manner, preventing eavesdropping by malware, viruses, bots, and the like, so as to maintain voice and data security of communications, and the like. Such a reduction in exposure can be achieved by moving sensitive data, processes, functionality, and the like, out of a main system portion of a device, such as mobile phone, tablet, personal computers, and the like, to a secluded system capable of storing, processing and encrypting/decrypting communication data, and the like, and then streaming the encrypted data to/from the main system. The illustrative system and method can eliminate a need for encrypting/decrypting communication data on the main system by performing encryption/decryption jobs on the secluded system. Advantageously, malware, and the like, does not have access to the main system, thus preventing data and encryption/decryption keys, and the like, from being exposed to malware that runs on the main system. The illustrative system and method can secure usage of connected audio devices, such speakers, microphones, and the like, wherein software drivers thereof typically have access to unencrypted voice data in the main system before the data is sent to/from a VoIP client where a malware program can get access to such unencrypted data while the data is being sent from/into a physical audio device into/from the main system resources (e.g., shared memory, etc.) for further processing and/or streaming. This novel functionality is achieved by connecting/pairing external audio devices, such BlueTooth headsets, speakers, and the like, with the secluded system, which can reside inside a designated device, such as a microSD, SD device, a MMC device, a USB dongle device, a protective case device, and the like. Data encryption/decryption occurs on the secluded system, which is secluded from the main phone/tablet/computer system, such that malware, and the like, will not have access thereto even if security of the main system is compromised, as the streamed data to/from the main system is encrypted and there is time where such data is unencrypted in the main system of the phone, tablet, computer, and the like, device. A private communication channel can be established between the secluded and main systems, whereby keys, data, and the like, is exchanged therebetween in secure manner without providing access to any malicious code or system therebetween and hence providing security, preventing eavesdropping, and the like.

Accordingly, in an illustrative aspect, there is provided a system, method and computer program product for secure voice over IP (VoIP) communications between computer devices, including a mobile device having a voice over IP (VoIP) application running thereon; a memory device having an encryption and decryption application, and an audio interface application running thereon; and a bus for providing communication between the mobile device and the memory device. The encryption and decryption application is configured to encrypt data transmitted to and received from the VoIP application over the bus. The encryption and decryption application is configured to decrypt the data received from the VoIP application before sending the decrypted data to the audio interface application.

The audio interface application is configured to interface with an audio device, including a Bluetooth audio device.

The memory device is one of a Secure Digital (SD) memory device and a MultiMediaCard (MMC) memory device, and the bus is one of a SD bus, and a MMC bus, respectively.

Still other aspects, features, and advantages of the present invention are readily apparent from the following detailed description, simply by illustrating a number of illustrative embodiments and implementations, including the best mode contemplated for carrying out the present invention. The present invention also is capable of other and different embodiments, and its several details can be modified in various respects, all without departing from the spirit and scope of the present invention. Accordingly, the drawings and descriptions are to be regarded as illustrative in nature, and not as restrictive.

### BRIEF DESCRIPTION OF THE DRAWINGS

The embodiments of the present invention are illustrated by way of example, and not by way of limitation, in the figures of the accompanying drawings, in which like reference numerals refer to similar elements, and in which:

FIG. 1 is an illustrative system for secure voice over IP (VoIP) communications, according to the present invention; and

FIGS. 2A-2C is an illustrative flow diagram that describes operation of the secure VoIP communication of FIG. 1, according to the present invention.

### DETAILED DESCRIPTION OF THE PREFERRED EMBODIMENTS

The present invention include recognition that systems and methods for communications between people over devices, such as phones, tablets, personal computers systems, and the like, can be achieved in the way that prevents eavesdropping, and the like, by malware, and the like, that may be present and run on the main system of a device, such as mobile phones, and the like. In a typical, non-secure, device system, a voice over IP (VoIP) communications or any other suitable data transfer application runs on a main system of the device, which receives or sends unencrypted audio data from/to physically connected audio devices, such as microphones, speakers, and the like, through media, such as RAM, which can be accessible to malware, and the like, thus exposing such unencrypted data to eavesdropping, and the like. Furthermore, once the unencrypted data is transferred to RAM that is accessible by a VoIP application, the VoIP application will then encrypt the data prior to sending it out, providing a point of time where the VoIP application uses encryption keys, and the like, either directly on a main processor of the device system or indirectly by using hardware acceleration, and the like. Thus, the encryption keys can pass from the operating RAM where VoIP application resides creating the risk of exposing such sensitive information (e.g., encryption keys, etc.) to potential malware, and the like, that is capable of accessing the environment of the running VoIP application, allowing for eavesdropping, compromise, and the like, of the encryption keys.

Advantageously, the illustrative system and method eliminates the above and other risks of eavesdropping, and the like, of unencrypted communication data, security keys, and the like, by eliminating presence thereof in unencrypted form on the main system of the device. Accordingly, the illustrative system and method connects, pairs, and the like, data sources, such as audio recording, rendering devices, and the like, to a secluded system that does not use and/or share memory resources, and the like, with the main system of the device, but rather has its own resources and environment where data encryption/decryption occurs, such that only encrypted data travels across a communication channel between the main system and the secluded system of the device.

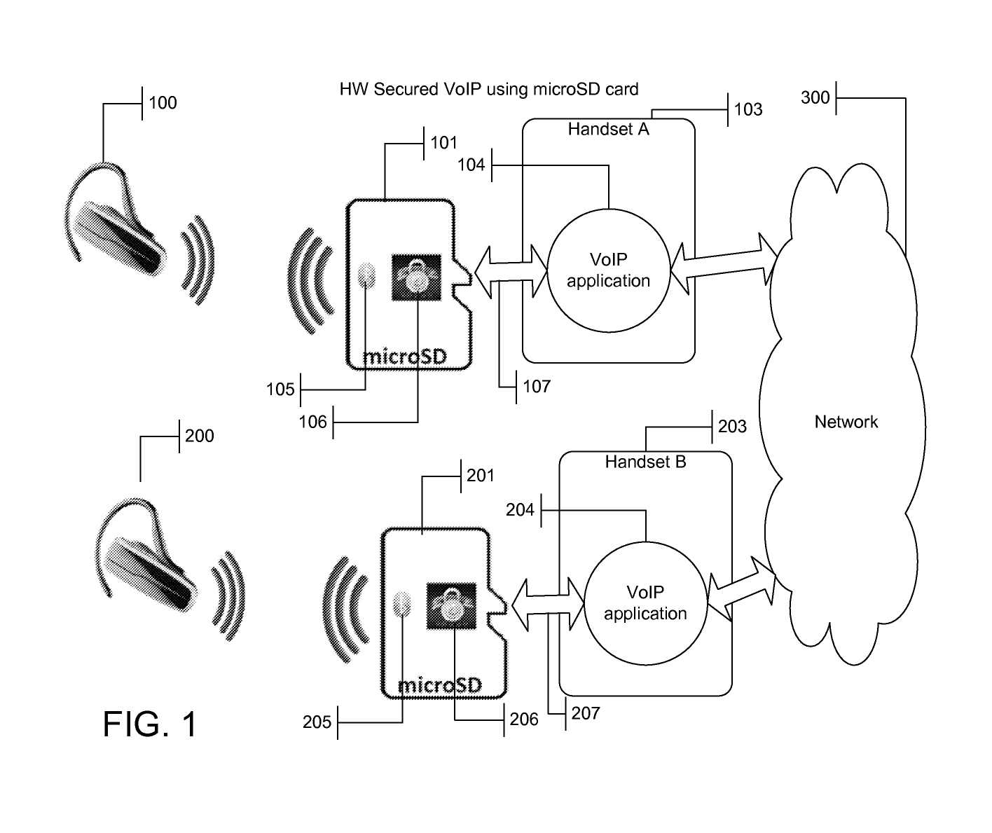

Referring now to the drawings, wherein like reference numerals designate identical or corresponding parts throughout the several views, and more particularly to FIG. 1 thereof, there is shown an illustrative system for secure voice over IP (VoIP) communications, according to the present invention. In FIG. 1, the illustrative system can include an illustrative application 104 and 204, such as a secure VoIP application, and the like, a memory device or card 101 and 201, such as a microSD device, and the like, that can be paired with an audio device 100 and 200, such as a BlueTooth headset, and the like, with data transfer over mobile devices 103 and 203, such as mobile phones, handsets, and the like.

Accordingly, the microSD cards 101 and 201 can be configured to provide for secure, private communications between the mobile devices 103 and 203, wherein audio data that is created or rendered on the external audio devices 100 and 200 is paired with the cards 101 and 201 over Bluetooth links 105 and 205, respectively. The audio signal that is received by interface 105 is encrypted by a crypto engine 106 and then sent to the main system of the device or handset 103. The handset 103 thus receives encrypted data over the SD bus 107 via the VoIP application 104. The VoIP application 104 then sends the encrypted audio signal over a communications network 300 (e.g., Internet, LAN, VPN, cellular, etc.) to the VoIP application 204 running on the handset 203. The VoIP application 204 then sends the received encrypted audio to the card 201 that decrypt the audio stream using crypto engine 206. The card 201 then stream the decrypted audio via the interface 205 to the headset 200 for rendering, completing the process.

In a similar manner, secure communications can be provided in the opposite direction from the device 200 to the device 100, and visa versa. The VoIP applications 104 and 204 are configured to moderate voice calls, audio data, and the like, between the devices 100 and 200, while advantageously not allowing the devices 100 and 200 to have access to unencrypted data, security keys, and the like, of the systems of the devices 103 and 203.

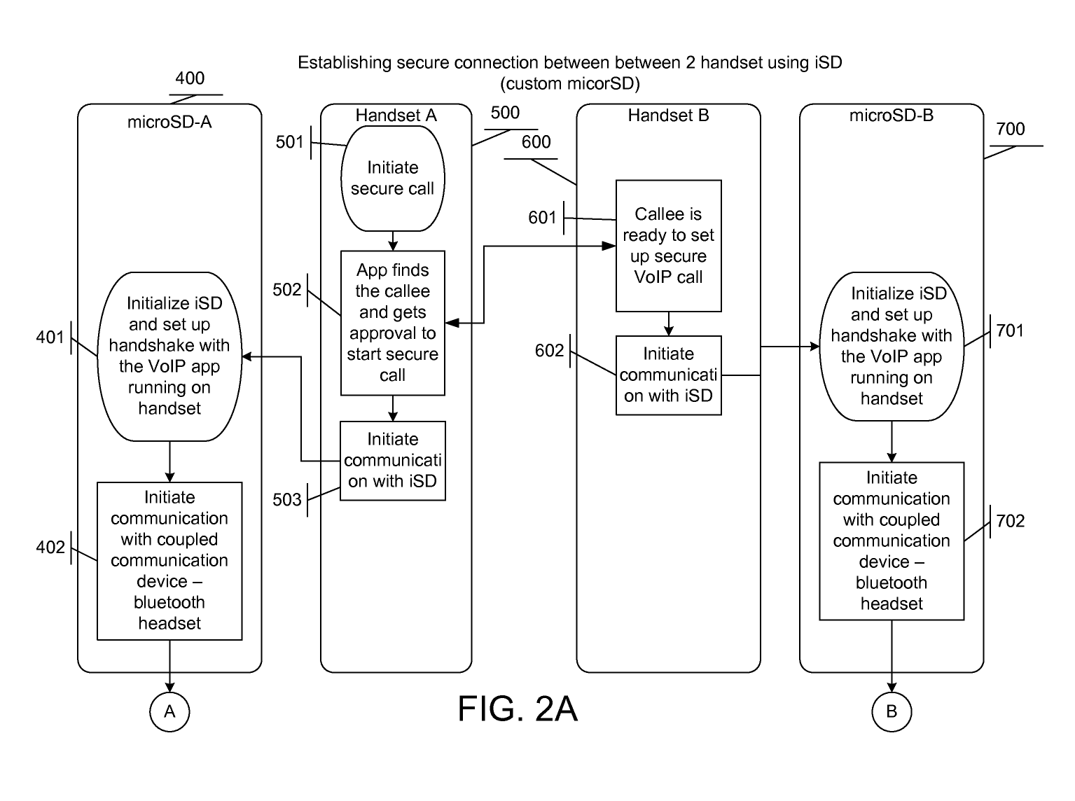

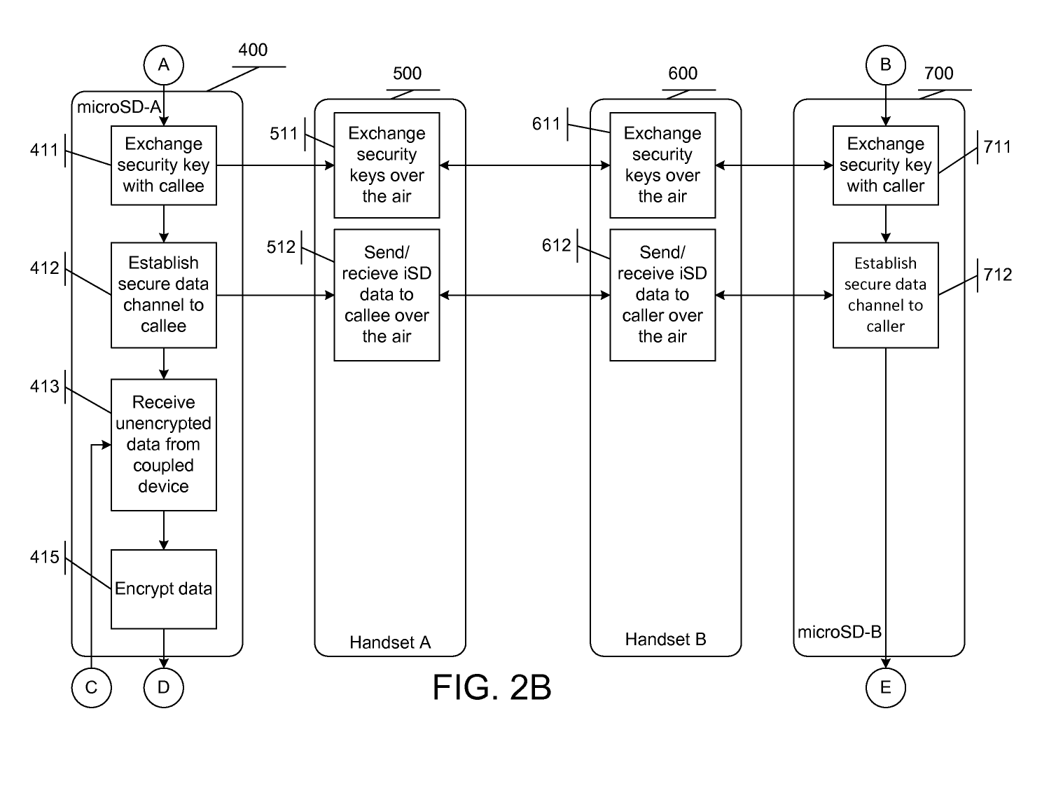

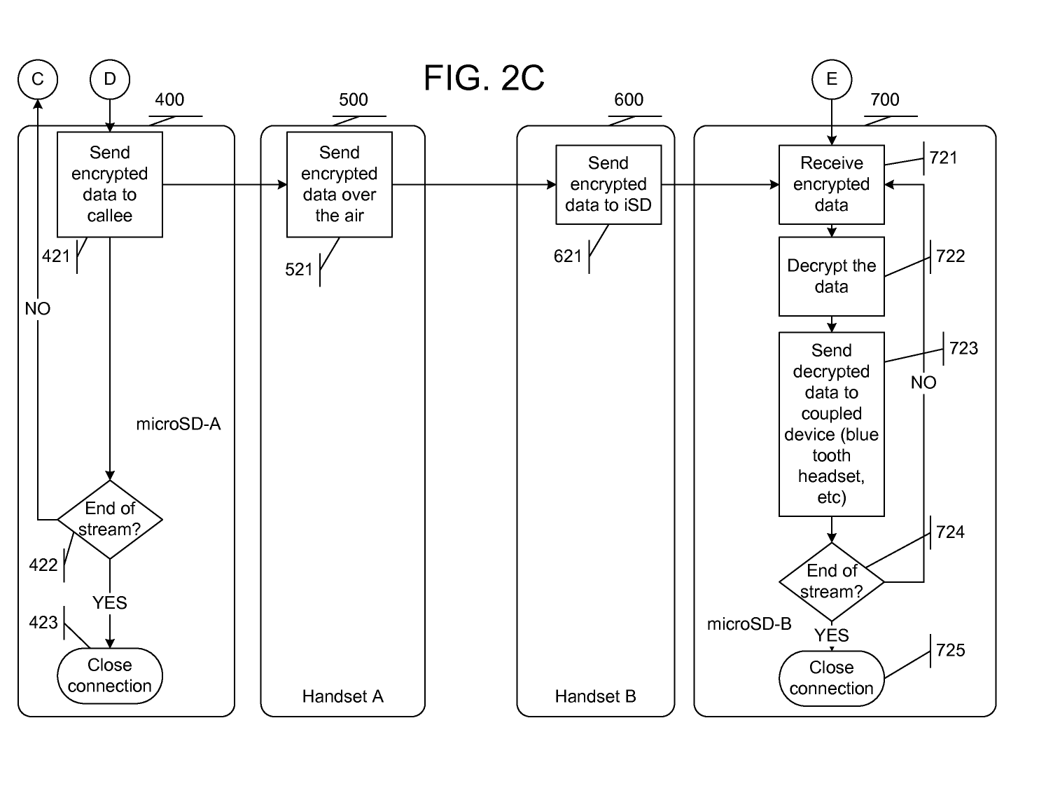

FIGS. 2A-2C is an illustrative flow diagram that describes operation of the secure VoIP communication of FIG. 1, according to the present invention. In FIGS. 2A-2C, is depicted how a call is started, managed, terminated, and the like, including points where communication data is encrypted and decrypted, as well as where and when security keys, and the like, are used, exposed, and the like. It is assumed that a user using a Handset A 500 is initiating a call (e.g., is the caller) to a user using Handset B 600 (e.g., the callee). Accordingly, the direction of communication is from Handset A 500 to Handset B 600. However, a similar flow applies when roles change in terms of call initiation, as well as when the user on the Handset B side 600 is talking as opposed to listening, as depicted in FIGS. 2A-2C.

Accordingly, the user using the Handset A 500 initiates a secure call at step 501 to the user using Handset B 600. The VoIP application on device 500 at step 502 then initiates an initial handshake with the VoIP application running on the device 600 and when the user of the device 600 is ready to accept the call at step 601 both of the VoIP applications on the devices 500 and 600 initiate communication with the two instances of the illustrative microSD devices 400 and 700 at steps 503 and 602, respectively.

The VoIP application on the device 500 then initiates communication with the device 400, which starts/resumes operation at step 401. After the system is ready on the device 400 and the handshake with the device 500 is established, the device 400 initiates communication with an external audio device, such as a BlueTooth headset, and the like, at step 402. Similarly, the VoIP application on the device 600 initiates communication at step 602 with the device 700, which starts/resumes operation at step 701. After the system is ready on the device 700 and the handshake with the device 600 is established, the device 700 initiates communication with an external audio device, such as a BlueTooth headset, and the like, at step 702.

After the above steps, a private, secure connection is established between the devices 400 and 700. For example, in FIG. 2B, at steps 411, 511, 611 and 711, the device 400 exchanges security keys with the device 700. Then, the devices 400 and 700 can establish a secure communication channel at steps 412, 512, 612 and 712. At this time, data leaving or entering both instances of the devices 400 and 700 on the respective SD bus that connects the devices 400 and 700 to the handsets A and B, 500 and 600, is encrypted by the devices 400 or 700, respectively. Advantageously, neither of the handset devices 500 and 600, including the applications, operating system, device drivers, and the like, running thereon are exposed to unencrypted data nor are security keys thereof compromised, eliminating the risk of eavesdropping of the communication data, security keys, and the like, by potentiation malware that might be running on either of the handset devices 500 and/or 600.

The device 400 then can receive audio data from an audio source over a Bluetooth link at step 413, encrypt the received data at step 415, and stream the encrypted date at step 421 of FIG. 2C to the VoIP application running on the device 500. The device 500 then in turn sends the encrypted data at step 521 to the VoIP application running on the device 600. The device 600 then receives the encrypted data or audio stream at step 621 and sends the encrypted data to the device 700 at step 621.

The devices 700 then receives the encrypted audio stream at step 721, decrypts the received data at step 722, and send the decrypted data to the coupled audio rendering device, such as a Bluetooth headset, and the like, at step 723. The devices 700 then checks if an end of data stream is detected at step 724, and otherwise waits for new data to arrive at step 721. Otherwise, processing continues to step 725 where the call is ended, the connection is closed, and the like.

Similarly, the device 400 can check if an end of data stream is detected at step 422, and otherwise waits for new data to arrive at step 413. Otherwise, processing continues to step 423 where the call is ended, the connection is closed, and the like. In a similar manner, data can be securely processed from the device 700 to the device 400, and visa versa.

The above-described devices and subsystems of the illustrative embodiments can include, for example, any suitable servers, workstations, PCs, laptop computers, PDAs, Internet appliances, handheld devices, cellular telephones, wireless devices, other electronic devices, and the like, capable of performing the processes of the illustrative embodiments. The devices and subsystems of the illustrative embodiments can communicate with each other using any suitable protocol and can be implemented using one or more programmed computer systems or devices.

One or more interface mechanisms can be used with the illustrative embodiments, including, for example, Internet access, telecommunications in any suitable form (e.g., voice, modem, and the like), wireless communications media, and the like. For example, employed communications networks or links can include one or more wireless communications networks, cellular communications networks, cable communications networks, satellite communications networks, G3 communications networks, Public Switched Telephone Network (PSTNs), Packet Data Networks (PDNs), the Internet, intranets, WiMax Networks, a combination thereof, and the like.

It is to be understood that the devices and subsystems of the illustrative embodiments are for illustrative purposes, as many variations of the specific hardware and/or software used to implement the illustrative embodiments are possible, as will be appreciated by those skilled in the relevant art(s). For example, the functionality of one or more of the devices and subsystems of the illustrative embodiments can be implemented via one or more programmed computer systems or devices.

To implement such variations as well as other variations, a single computer system can be programmed to perform the special purpose functions of one or more of the devices and subsystems of the illustrative embodiments. On the other hand, two or more programmed computer systems or devices can be substituted for any one of the devices and subsystems of the illustrative embodiments. Accordingly, principles and advantages of distributed processing, such as redundancy, replication, and the like, also can be implemented, as desired, to increase the robustness and performance the devices and subsystems of the illustrative embodiments.

The devices and subsystems of the illustrative embodiments can store information relating to various processes described herein. This information can be stored in one or more memories, such as a hard disk, optical disk, magneto-optical disk, RAM, and the like, of the devices and subsystems of the illustrative embodiments. One or more databases of the devices and subsystems of the illustrative embodiments can store the information used to implement the illustrative embodiments of the present invention. The databases can be organized using data structures (e.g., records, tables, arrays, fields, graphs, trees, lists, and the like) included in one or more memories or storage devices listed herein. The processes described with respect to the illustrative embodiments can include appropriate data structures for storing data collected and/or generated by the processes of the devices and subsystems of the illustrative embodiments in one or more databases thereof.

All or a portion of the devices and subsystems of the illustrative embodiments can be conveniently implemented using one or more general purpose computer systems, microprocessors, digital signal processors, micro-controllers, application processors, domain specific processors, application specific signal processors, and the like, programmed according to the teachings of the illustrative embodiments of the present invention, as will be appreciated by those skilled in the computer and software arts. Appropriate software can be readily prepared by programmers of ordinary skill based on the teachings of the illustrative embodiments, as will be appreciated by those skilled in the software art. In addition, the devices and subsystems of the illustrative embodiments can be implemented by the preparation of application-specific integrated circuits or by interconnecting an appropriate network of conventional component circuits, as will be appreciated by those skilled in the electrical art(s). Thus, the illustrative embodiments are not limited to any specific combination of hardware circuitry and/or software.

Stored on any one or on a combination of computer readable media, the illustrative embodiments of the present invention can include software for controlling the devices and subsystems of the illustrative embodiments, for driving the devices and subsystems of the illustrative embodiments, for enabling the devices and subsystems of the illustrative embodiments to interact with a human user, and the like. Such software can include, but is not limited to, device drivers, firmware, operating systems, development tools, applications software, and the like. Such computer readable media further can include the computer program product of an embodiment of the present invention for performing all or a portion (if processing is distributed) of the processing performed in implementing the illustrative embodiments. Computer code devices of the illustrative embodiments of the present invention can include any suitable interpretable or executable code mechanism, including but not limited to scripts, interpretable programs, dynamic link libraries (DLLs), Java classes and applets, complete executable programs, Common Object Request Broker Architecture (CORBA) objects, and the like. Moreover, parts of the processing of the illustrative embodiments of the present invention can be distributed for better performance, reliability, cost, and the like.

As stated above, the devices and subsystems of the illustrative embodiments can include computer readable medium or memories for holding instructions programmed according to the teachings of the present invention and for holding data structures, tables, records, and/or other data described herein. Computer readable medium can include any suitable medium that participates in providing instructions to a processor for execution. Such a medium can take many forms, including but not limited to, non-volatile media, volatile media, transmission media, and the like. Non-volatile media can include, for example, optical or magnetic disks, magneto-optical disks, and the like. Volatile media can include dynamic memories, and the like. Transmission media can include coaxial cables, copper wire, fiber optics, and the like. Transmission media also can take the form of acoustic, optical, electromagnetic waves, and the like, such as those generated during radio frequency (RF) communications, infrared (IR) data communications, and the like. Common forms of computer-readable media can include, for example, a floppy disk, a flexible disk, hard disk, magnetic tape, any other suitable magnetic medium, a CD-ROM, CDRW, DVD, any other suitable optical medium, punch cards, paper tape, optical mark sheets, any other suitable physical medium with patterns of holes or other optically recognizable indicia, a RAM, a PROM, an EPROM, a FLASH-EPROM, any other suitable memory chip or cartridge, a carrier wave, or any other suitable medium from which a computer can read.

While the present invention have been described in connection with a number of illustrative embodiments and implementations, the present invention is not so limited, but rather covers various modifications and equivalent arrangements, which fall within the purview of the appended claims.

What is claimed is:

1. A computer implemented system for secure voice over IP (VoIP) communications between computer devices, the system comprising:
a mobile device having a voice over IP (VoIP) application running thereon;
a memory device having an encryption and decryption application, and an audio interface application running thereon; and
a bus for providing communication between the mobile device and the memory device,
wherein the encryption and decryption application is configured to encrypt data transmitted to and received from the VoIP application over the bus, and
the encryption and decryption application is configured to decrypt the data received from the VoIP application before sending the decrypted data to the audio interface application.

2. The system of claim 1, wherein the audio interface application is configured to interface with an audio device, including a Bluetooth audio device.

3. The system of claim 1, wherein the memory device is one of a Secure Digital (SD) memory device and a MultiMediaCard (MMC) memory device, and
the bus is one of a SD bus, and a MMC bus, respectively.

4. A computer implemented method for secure voice over IP (VoIP) communications between computer devices, the method comprising:
running a voice over IP (VoIP) application with a mobile device;
running an encryption and decryption application, and an audio interface application with a memory device;
providing with a bus communication between the mobile device and the memory device;
encrypting data transmitted to and received from the VoIP application over the bus with the encryption and decryption application; and
decrypting the data received from the VoIP application with the encryption and decryption application before sending the decrypted data to the audio interface application.

5. The method of claim 4, wherein the audio interface application is configured to interface with an audio device, including a Bluetooth audio device.

6. The method of claim 4, wherein the memory device is one of a Secure Digital (SD) memory device and a MultiMediaCard (MMC) memory device, and
the bus is one of a SD bus, and a MMC bus, respectively.

7. A computer program product for secure voice over IP (VoIP) communications between computer devices and including one or more computer readable instructions embedded on a non-transitory, tangible computer readable medium and configured to cause one or more computer processors to perform the steps of:
running a voice over IP (VoIP) application with a mobile device;
running an encryption and decryption application, and an audio interface application with a memory device;
providing with a bus communication between the mobile device and the memory device;
encrypting data transmitted to and received from the VoIP application over the bus with the encryption and decryption application; and
decrypting the data received from the VoIP application with the encryption and decryption application before sending the decrypted data to the audio interface application.

8. The computer program product of claim 7, wherein the audio interface application is configured to interface with an audio device, including a Bluetooth audio device.

9. The computer program product of claim 7, wherein the memory device is one of a Secure Digital (SD) memory device and a MultiMediaCard (MMC) memory device, and
the bus is one of a SD bus, and a MMC bus, respectively.
